(19) United States
(12) Patent Application Publication
(10) Pub. No.: US 2012/0221222 A1
(43) Pub. Date: Aug. 30, 2012

(54) METHOD OF COMPENSATING FOR VEHICLE KINEMATICS IN CONTROLLING INDEPENDENT WHEEL MOTORS

(76) Inventors: Eric Anderson, Ames, IA (US); Todd Velde, Dubuque, IA (US)

(21) Appl. No.: 13/036,629

(22) Filed: Feb. 28, 2011

(51) Int. Cl. G06F 19/00

(52) U.S. Cl. 701/90; 701/1

(57) ABSTRACT

The present invention relates to a method of compensating for vehicle kinematics in a traction control system of an articulated vehicle. The vehicle has an independently-powered wheel. The method includes measuring a speed of the wheel, calculating an instantaneous ground speed of the wheel, and calculating a static ground speed of the wheel. The method further includes calculating a centerline ground speed of the wheel and comparing the centerline ground speed of the wheel to a reference speed.

### FIELD OF THE INVENTION

The present invention relates to a method of improving traction control, and in particular to a method of compensating for vehicle kinematics of an articulated vehicle having independent wheel drives.

### BACKGROUND OF THE INVENTION

Articulated vehicles are well-known in the prior art. A conventional articulated vehicle includes a pivoting joint which allows a front frame assembly to pivot relative to a rear frame assembly about a vertical axis. A front loader, for example, can be designed as an articulated vehicle. The front frame assembly can include an attachment coupled thereto and the rear frame assembly can include a cab portion. An attachment can include, for example, a bucket, a pair of forks, a blade, a rotary tiller, a roller level, a rotary cutter, a trencher, and other known attachments. The front frame assembly can further include a front axle and the rear frame assembly can have a rear axle. The front and rear axles can include wheels at each end thereof. Each wheel can be independently powered by an electric motor, hydraulic motor, engine, or other device for supplying power to the wheels. Many of these vehicles include conventional traction control systems for controlling vehicle performance.

Traction control systems have been increasingly innovative in off-highway vehicles in order to improve performance over a broad range of ground conditions. Many state of the art systems have been developed for use in off-highway equipment that utilize purely mechanical drivelines and various sensors to apply four wheel drive, differential locks, or wheel head brakes to aid in traction control of these systems. However, new technologies offering independent wheel control such as wheel motors (hydraulic or electric) provide new challenges and opportunities for traction control.

One component of a conventional traction control system for an articulating vehicle is the compensation for vehicle kinematics. Many conventional traction control systems determine vehicle speed based on an estimation of the different wheel speeds. Other conventional systems may incorporate the articulated angle of the vehicle for determining the ratio between the inner and outer wheels while articulating and driving through a turn. However, conventional traction control systems do not consider the change in steering angle when determining the optimal relative speeds of each wheel. Thus, these systems are unable to accurately determine reference ground speeds for each wheel, while the vehicle is articulating.

Therefore, a need exists for an improved traction control system that accurately determines individual wheel speeds while compensating for vehicle kinematics.

### SUMMARY

In one exemplary embodiment of the present disclosure, a method is provided for compensating for vehicle kinematics in a traction control system of an articulated vehicle. The vehicle includes independently-powered front wheels and independently-powered rear wheels. The method includes measuring a speed of the front wheels and rear wheels, calculating an instantaneous ground speed of the front wheels and rear wheels based on the measured speeds, and calculating a static ground speed of the front wheels and rear wheels based on the calculated instantaneous ground speeds. The method further includes calculating a centerline ground speed of the front wheels and rear wheels based on the calculated static ground speeds and comparing each of the centerline ground speeds of the front wheels to each of the centerline ground speeds of the rear wheels.

In one aspect, the method also includes determining a radius of each front wheel and rear wheel, calculating an angular velocity of each front wheel and rear wheel from the measured speeds, and calculating the instantaneous ground speeds of the front wheels and rear wheels based on the radius and angular velocity of each wheel. In another aspect, the method can include calculating an articulation velocity offset of the front wheels and rear wheels. In this aspect, the method comprises measuring an articulation angle of the vehicle, determining an articulation angle velocity based on the measured articulation angle, determining a treadwidth value, and calculating a vehicle geometry function value. The articulation velocity offset is a function of the articulation angle velocity, the treadwidth value, and the vehicle geometry function value.

In a different aspect, the method can further include calculating the static ground speed based on the articulation velocity offset and calculated instantaneous ground speed of the front wheels and rear wheels. In addition, the method may include determining a treadwidth value and wheel base value. The wheel base value is the distance between the front wheels and rear wheels. A turning radius of the vehicle can be determined, and the articulation angle ratio is calculated as a function of the treadwidth value, the wheel base value, and the turning radius. The centerline ground speeds of the front wheels and rear wheels can be calculated based on the articulation angle ratio and calculated static ground speeds.

In an alternative aspect, the method can also include calculating the difference between the centerline ground speeds of the front wheels and the rear wheels and controlling the measured speeds of the front wheels and rear wheels until the difference in the centerline ground speeds is approximately zero. Further, the method can include calculating a first difference between the centerline ground speeds of the front wheels and calculating a second difference between the centerline ground speeds of the rear wheels. The speeds of the front wheels and rear wheels can be controlled to reduce the first difference and second difference, respectively, to approximately zero.

In another embodiment, a method of reducing slip in an articulating vehicle is provided. The vehicle includes independently-powered front wheels and rear wheels. The method includes determining a reference vehicle speed, calculating a static ground speed of the front wheels and rear wheels based on the reference vehicle speed, calculating an instantaneous ground speed of the front wheels and rear wheels based on the calculated static ground speeds, and calculating expected speeds of the front wheels and rear wheels based on the calculated instantaneous ground speeds. The method further includes measuring a speed of the front wheels and rear wheels and comparing the measured speed of each wheel to the calculated expected speed of each wheel.

In one aspect of this embodiment, the reference vehicle speed can be determined by averaging the measured speeds of the front wheels and rear wheels. Alternatively, the reference vehicle speed can be determined by selecting the slowest measured speed or the fastest measured speed. The reference vehicle speed can also be determined by measuring vehicle speed with an accelerometer, a radar detector, a global positioning sensor, or measuring the speed of an unpowered wheel coupled to the vehicle. The accelerometer can measure vehicle acceleration, which in turn can be computed to determine vehicle speed according to any known method.

In another aspect, the method includes determining a treadwidth value and a wheel base value. The wheel base value is the distance between the front wheels and rear wheels. The method includes determining a turning radius and calculating an articulation angle ratio based on the treadwidth value, wheel base value, and turning radius. In a related aspect, the method can include calculating the static ground speed based on the articulation angle ratio and reference ground speed.

In a different aspect, the method can include calculating an articulation velocity offset of the front wheels and rear wheels. In this aspect, the method can further include measuring an articulation angle of the vehicle, determining an articulation angle velocity based on the measured articulation angle, determining a treadwidth value for the front wheels and rear wheels, and calculating a vehicle geometry function value. Accordingly, the articulation velocity offset is a function of the articulation angle velocity, the treadwidth value, and the vehicle geometry function value. Related thereto, the method can also include calculating the instantaneous ground speed based on the articulation velocity offset and calculated static ground speed of the front wheels and rear wheels.

In another embodiment, the method can include determining a radius of each of the front wheels and rear wheels and calculating the expected speeds of the front wheels and rear wheels based on the radius and calculated instantaneous ground speeds of each wheel. In addition, the method can also include calculating the difference between the expected speed and measured speed of each front wheel and rear wheel and controlling the speed of each of the front wheels and rear wheels until the difference in the expected speed and measured speed of each wheel is approximately zero.

The embodiments of the present disclosure provide many advantages over the prior art. For example, the vehicle speed can more accurately be determined by determining the articulation velocity of the vehicle. This can enhance the traction control of the vehicle.

In addition, the algorithm for determining vehicle speed can also account for operator feedback. For instance, a sensor can detect movement in a joystick or steering wheel and provide input to a controller for measuring articulation velocity. Alternatively, the algorithm can also account for a feedback response in which a sensor positioned at or near the articulation joint can detect a change in the articulation angle as the vehicle moves.

The traction control of an articulating vehicle can be improved and slip between the wheels and ground surface reduced by compensating for vehicle kinematics. Various algorithms consider the vehicle kinematics and compare estimated vehicle speeds for each independently powered wheel or expected wheel speeds versus measured wheel speeds. Differences between expected speeds and measured speeds, while taking into account the articulation angle velocity of the vehicle, can be minimized by the algorithms described in the present disclosure. As a result, slip is reduced and vehicle traction can be increased.

### BRIEF DESCRIPTION OF THE DRAWINGS

The above-mentioned aspects of the present invention and the manner of obtaining them will become more apparent and the invention itself will be better understood by reference to the following description of the embodiments of the invention, taken in conjunction with the accompanying drawings, wherein:

FIG. 1 is a side view of an articulated vehicle;

FIG. 2 is a schematic view of the articulated vehicle of FIG. 1;

FIG. 3 is a flow diagram of an algorithm for improving traction control of an articulating vehicle; and

FIG. 4 is a flow diagram of another algorithm for improving traction control of an articulating vehicle.

Corresponding reference numerals are used to indicate corresponding parts throughout the several views.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

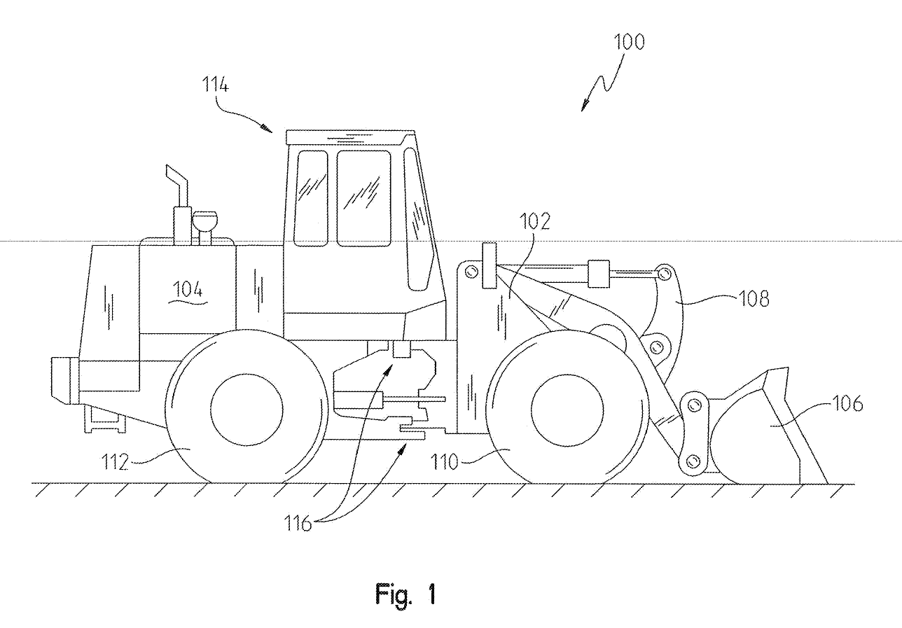

The present disclosure relates to an articulated vehicle and a method for estimating its vehicle speed. Referring to FIG. 1, an exemplary embodiment is shown of an off road work vehicle in the form of a four wheel drive loader 100. The vehicle 100 can include a front frame assembly 102 and a rear frame assembly 104 that are pivotally joined together at an articulation pivot or joint 116.

The front frame assembly 102 can be supported by a front drive wheel 110 and the rear frame assembly 104 can be supported by a rear drive wheel 112. The front frame assembly 102 is also provided with a work implement in the form of a loader bucket 106 that is controllably coupled to the front frame assembly 102 by a coupler or mechanical linkage 108. In other embodiments, the front frame assembly 102 can be coupled with a pair of forks, a blade, a rotary tiller, a roller level, a rotary cutter, a trencher, and other known work implements. The rear frame assembly 104 can include an operator cab 114 in which an operator controls the vehicle 100. The controls can include a joystick or steering wheel (not shown) for controlling movement of the front wheel 110 and rear wheel 112 and articulating the front frame assembly 102 relative to the rear frame assembly 104.

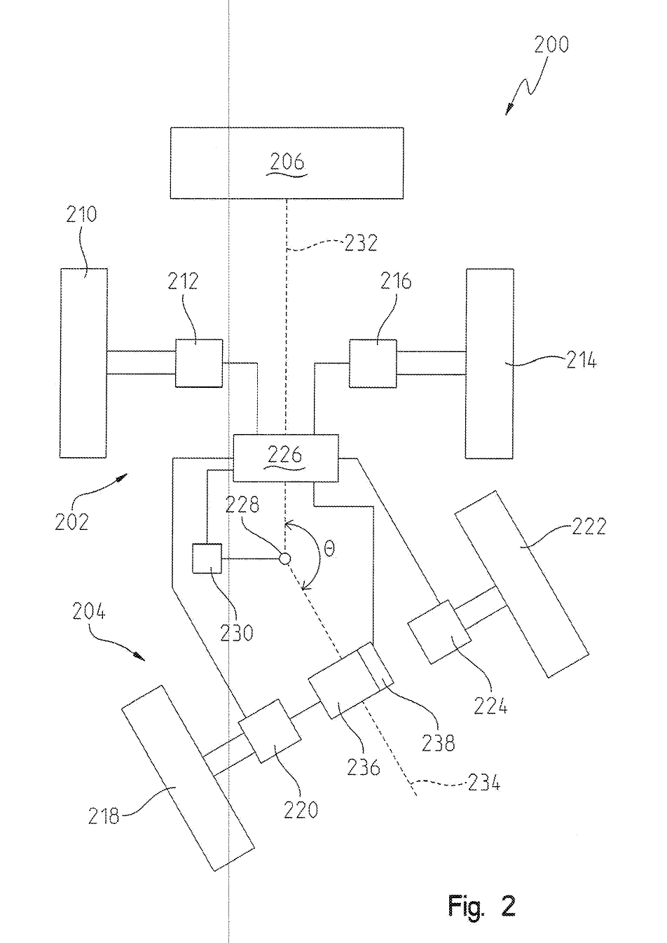

In the illustrated embodiment of FIG. 2, an off road, articulated vehicle 200 is shown which is similar to the vehicle 100 described above. The articulated vehicle 200 includes a front assembly 202 and a rear assembly 204. A work implement 206, such as a bucket, can be coupled to the front assembly 202.

The vehicle 200 can also include independently powered wheels. For instance, the front assembly 202 can be supported by a pair of independently powered front wheels 210, 214. A first front wheel 210 can be powered by an electric motor 212, a hydraulic motor, or other known power device. Likewise, a second front wheel 214 can be powered by a different electric motor 216. The rear assembly 204 can also be supported by independently powered wheels. As shown in FIG. 2, the rear assembly 204 can be supported by rear wheels 218, 222. The rear wheel 218 can be powered by an electric motor 220 and the other rear wheel 222 can be powered by a different electric motor 224. Other devices such as hydraulic motors, internal combustion engines, etc. can be used for providing power to the wheels.

Similar to the vehicle 100 of FIG. 1, the vehicle 200 can also include a cab (not shown) in which a vehicle operator can control the vehicle 200. The cab may include a plurality of controls including a steering wheel or joystick 236 for controlling the articulation of the front assembly 202 and rear assembly 204. A user control sensor 238 can be electrically coupled to the steering wheel or joystick 236 to detect movement thereof. The user control sensor 238 is also electrically coupled to a controller 226 so that detected movements and measurements made by the user control sensor 238 can be communicated to the controller 226.

The vehicle 200 includes an articulation pivot or joint 228 such that the front assembly 202 can move relative to the rear assembly 204. Referring to FIG. 2, the front assembly 202 can be defined along a first longitudinal axis 232 and the rear assembly 204 can be defined along a second longitudinal axis 234. In the illustrated embodiment, the angle at which the rear assembly 204 is disposed relative to the front assembly 202 is defined as the articulation angle θ. When the vehicle 200 is moving in a substantially straight line, for example, the angle θ is approximately 180°. As the vehicle 200 makes a right turn, the articulation angle θ is less than 180°. Alternatively, as the vehicle 200 makes a left turn, the articulation angle θ is greater than 180°

The articulation angle θ can be measured by an articulation angle sensor 230, which can be positioned near the joint 228. In a different embodiment, the sensor 230 can be positioned along a hydraulic cylinder. As the articulation angle θ changes, the sensor 230 can transmit the detected angle θ to the controller 226. The controller 226 has the ability to receive signal inputs from various sources, including the articulation sensor 230 and user control sensor 236, and produce output signals. For instance, the controller 226 can control the amount of torque transmitted to the front wheels 210, 214 and rear wheels 218, 222. The controller 226 can include algorithms, software, etc. for controlling the operation of the vehicle 200.

One goal of a vehicle's traction control system is to prevent or reduce slippage of the front and rear wheels as the vehicle turns. As a vehicle turns, the wheels rotate at different speeds. This is particularly true for an articulating vehicle such as the one shown in FIG. 2. If the vehicle 200 makes a right turn, the inner wheels, i.e., wheels 214, 222, rotate at a slower speed than the outer wheels, i.e., wheels 210, 218. This is because the inner wheels have a smaller turning radius than the outer wheels, which is a function of the articulation angle θ.

In the illustrated embodiment of FIG. 2, the articulated vehicle 200 has independently powered wheels, i.e., each wheel has its own power source, e.g., electric motor, for providing torque to the wheel. In other words, the vehicle 200 has an independent ability to apply torque to different sides thereof. To prevent one of the wheels from slipping, the controller 226 controls the amount of torque being transmitted to each wheel. There is a relationship between the vehicle speed and the individual wheel speed, and the present disclosure considers this relationship and the angle of articulation θ for estimating the vehicle speed. In other words, the improved traction control system can compare expected wheel speed values and actual wheel speed values to reduce slip, but to do so the effects of ground speed, articulation angle, articulation velocity, and slip are taken into consideration. The rate of change of the articulation angle, or articulation angle velocity, is a dynamic component that is relevant to the determination of overall vehicle speed but is not considered in most conventional traction control systems. Unlike conventional traction control systems, the embodiments of the present disclosure consider mapping operator command and actual vehicle output by compensating for steering and articulation. In addition, traction control is achieved by the embodiments herein without disregarding the kinematic effects of the vehicle. As a result, scrubbing of the wheels, unbalanced load distribution, and other losses can be avoided with this type of traction control system.

The following example is provided to further emphasize the importance of including articulation angle velocity as a component in the determination of vehicle speed. In FIG. 2, the articulated vehicle 200 can be a front loader, for example, with a bucket 206 for transporting dirt. As an example, suppose the vehicle 200 is not moving as it collects dirt in the bucket 206. As shown, the rear assembly 204 is articulated with respect to the front assembly 202 at an articulation angle less than 180°. In other words, the second axis 234 is not coaxial with the first axis 232. In this position, if the operator wants to straighten the wheels such that the first axis 232 and second axis 232 are substantially coaxial, the front wheels 210, 214 and rear wheels 218, 222 must move to avoid sliding any of the wheels laterally. As the front wheels 210, 214 and rear wheels 218, 222 roll into alignment, the rear assembly 204 articulates with respect to the front assembly 202 and therefore the articulation angle θ changes.

In this example, the vehicle 200 moves a short distance, if at all, and thus most conventional traction control systems would estimate there is no vehicle speed. However, this can result in one or more wheels slipping or sliding laterally. The consequences of not considering the effects of articulation velocity can constitute increased wheel wear and possibly cause the traction control system to work against the vehicle's effort to articulate, thereby resulting in increased wear on the vehicle, undesirable steering performance, and increased fuel consumption. Each of the front wheel and rear wheel speeds can be measured and the articulation angle θ can be detected by the articulation angle sensor 230. Each of the wheel speeds is related to the change in articulation angle, or articulation angle velocity, and the kinematic relationship between the measured speeds and articulation angle velocity can be used for accurately estimating vehicle speed.

As described above, the articulated vehicle includes independently powered wheels. The wheel speed can be measured according to any known technique, such as using a resolver or encoder. An example of a resolver is the R11X-2J10/7G brushless resolver sensor manufactured by Advanced Micro Controls Inc.

As also described above, the articulated vehicle 200 shown in FIG. 2 can include a cab in which a vehicle operator is positioned for controlling the vehicle. The cab can include a steering wheel or joystick 236. Other controls, such as an accelerator pedal and brake pedal, can also be provided in the cab. The user control sensor 238 can detect movement of the steering wheel or joystick 236 and transmit a signal to the controller 226. As a result, the controller 226 can use the operator steering commands for estimating vehicle speed and thereby provide optimal traction control.

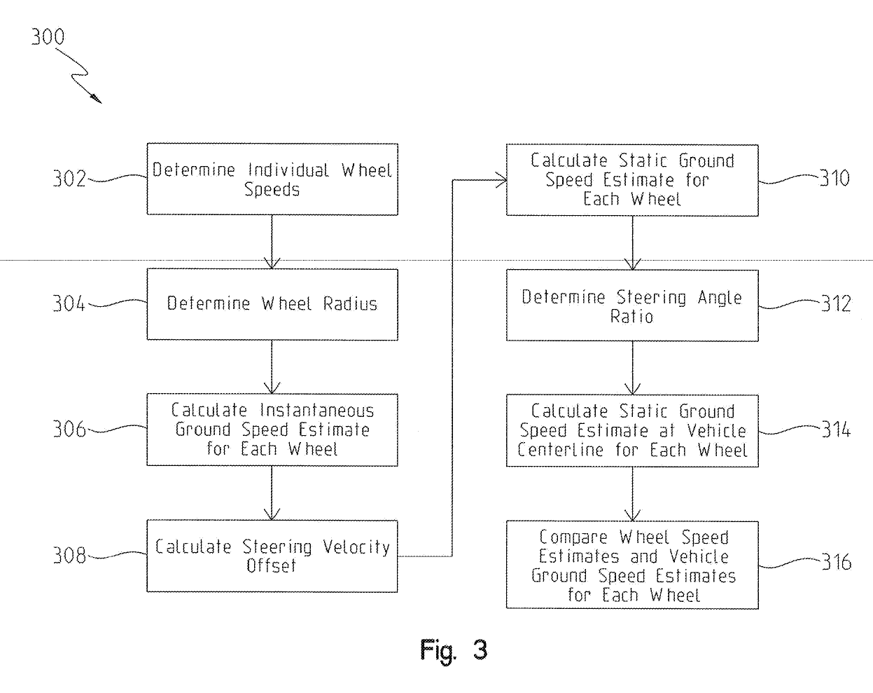

To achieve desirable traction control in an articulating vehicle such as those shown in FIGS. 1 and 2, the steering angle and kinematic relationship between wheel speeds and articulation angle are considered. In a first exemplary embodiment shown in FIG. 3, an algorithm 300 can be downloaded into the controller 226 for improving traction control. Referring to the algorithm 300, a first step 302 is to determine the speed of each individual wheel. For a front loader, for example, this includes determining the speed of two front wheels and two rear wheels. For an articulating dump truck, however, this can include measuring the speed of six or more wheels. The present disclosure is not limited to any quantity of wheels and therefore is applicable to any articulating vehicle. As described above, wheel speed can be measured using an encoder, resolver, or any other known technology for measuring rotational wheel speed.

The measured motor speed in step 302 can be referred to as an angular velocity measured in radians per second or degrees per second. Although not shown in FIG. 2, each individual motor is coupled to a drive assembly which transfers torque to each wheel. The drive assembly can include gearsets, clutch assemblies, bearings, shafts, etc. for producing different ranges or ratios. The drive ratio can be determined as a ratio of the input speed and output speed of the drive assembly. In step 302, the motor speed measurement is divided by the drive ratio for each wheel to compute the angular velocity of the wheel. The angular velocity of the wheel is the wheel speed about its axis of rotation. Once each wheel speed, or angular velocity, is determined in step 302, the radius of each wheel is determined in step 304. The wheel radius can be a nominal value, an estimated value, or measured value. The nominal value is an expected value for the wheel radius, and this value is used in the absence of a measurement or estimated radius. There are multiple factors that affect a wheel's nominal radius. For example, a wheel may be designed to have a nominal radius of one meter. However, this radius can differ if the wheel is made by different manufacturers or if two wheels are made by the same manufacturer but inflated at different pressures. The radius can further differ on two wheels at the same inflation pressure with different wear. The radius of the wheel can change based on static and dynamic loads imposed on the wheel. The change in wheel radius may differ from the nominal value by a few millimeters or centimeters.

In step 306, the instantaneous ground speed can be estimated for each wheel. To do so, the ground speed is calculated by multiplying the wheel angular velocity by the wheel radius for each wheel.

Once the instantaneous ground speed for each wheel is calculated, the algorithm 300 continues to step 308 to calculate a steering velocity offset or articulation velocity offset. The offset is a function of articulation angle velocity, treadwidth, and a function of the geometry of the vehicle. In particular, the offset can be calculated as follows:

Articulation Velocity Offset=Articulation Angle Velocity*Treadwidth/2*f(geometry)

The articulation angle velocity is the rate of change of the articulation angle, θ. In other words, the articulation angle velocity is the speed of articulation or the relative angular velocity of the front and rear frame assemblies about its axis or joint 228 (see FIG. 2). The articulation angle velocity can be determined on the basis of a feedback response or operator command response. As a feedback response, the articulation angle velocity can be measured or calculated. With reference to FIG. 2, for example, a sensor 230 can be positioned near the articulation joint 228 and measure the articulation angle velocity. Alternatively, the controller 226 can measure the rate of change of the articulation angle, θ, over a period of time and calculate the articulation angle velocity.

In a different aspect, the articulating vehicle 200 can include a joystick or steering wheel 236 for steering the vehicle 200. In this aspect, the vehicle 200 can further include a user control sensor 238 for detecting movements of the joystick or steering wheel 236 as an operator commands a response from the vehicle 200. The sensor 238 can communicate the detected movements of the joystick or steering wheel 236 to the controller 226 and the controller 226 can then compute the vehicle's articulation angle velocity.

The treadwidth is a distance perpendicular from the articulation joint (e.g., joint 228 in FIG. 2) to the wheel footprint center. The wheel footprint center is a point in which the wheel contacts the ground. In actuality, the wheel has a thickness of tread that is in contact with the ground and is referred to as a patch. When the vehicle turns or articulates, the wheel also turns and thus rotates with respect to the ground. The patch also rotates with respect to the ground as the wheel rotates, but a point of the patch does not slide because of the rotation. The distance from the center of rotation of the wheel to this point of the patch that is not sliding is referred to as the turning radius of the wheel. Since this point does not slip, but rather rotates, it dictates the speed that the wheel should turn.

The vehicle geometry function, f(geometry), describes how the articulation angle velocity maps to the longitudinal velocity of each wheel. For example, with respect to the vehicle 200 in FIG. 2, the front assembly 202 includes a front axle and the rear assembly 204 includes a rear axle. As the vehicle articulates, the movement of the front assembly is a combination of rotation about a center point along the front axle and translation in the direction in which the front wheels 210, 214 are pointed (if not, then the front wheels are slipping sideways, something which is to be avoided). The center points of the front and rear axles move with respect to each other. The amount or value of this longitudinal movement required is a function of the articulation angle θ, articulation angle velocity, and distance between each axle center and the articulation joint 228. This variable differs depending on the type of vehicle and its geometry. In some vehicles, the distance between the articulation joint to each axle can be about the same.

Once the articulation angle velocity, treadwidth, and vehicle geometry function are known, the articulation velocity offset can be determined from the formula above for each wheel. After this, the static ground speed can be estimated for each wheel in step 310. To do so, the static ground speed is the sum of the instantaneous ground speed (determined in step 306) and the corresponding offset value for that wheel.

In step 312, the steering angle ratio is determined. The ratio is a function of the treadwidth, turning radius, articulation angle, and the vehicle geometry function, f(geometry). In particular, the ratio can be calculated as follows:

Ratio=1/(1±Treadwidth/(2*R))

where, R is the turning radius. The plus or minus sign in the formula above is representative of whether the wheel speed must increase or decrease during the articulation, depending on whether it is on the outside or inside of the turn. The turning radius, R, can be determined as a function of wheel base, or the length from the front wheels to the rear wheels. The calculation for the turning radius is known in the art. One example is as follows:

Turning Radius=Wheel Base/2*cot(articulation angle*f(geometry))

Once the steering angle ratio is known for each wheel, the static ground speed estimates at the vehicle centerline can be calculated in step 314. The vehicle centerline speed can be computed as the static ground speed of each wheel (determined in step 310) multiplied by the ratio determined in step 312. As a result, there are four different vehicle centerline speeds, one for each wheel.

Referring to step 316, the controller compares the values of each adjusted wheel speed with the vehicle centerline speed estimates found in step 314. The difference between the two speeds for each wheel should be approximately zero under ideal tractive conditions. The wheel speeds have been adjusted for steering kinematics, which is advantageous over most conventional traction control systems. In the event the difference between the adjusted wheel speed and vehicle ground speed is not zero, efforts can be made to reduce this difference to approximately zero.

In a non-limiting example, the wheel speed can be measured for four different wheels and a ground reference speed can be estimated from these measured speeds. For instance, the reference speed can be selected as the lowest speed or calculated as an average of all measured speeds. The difference between the measured wheels speeds and reference speed can be calculated and apply a transfer function, for example, to the difference to obtain a result. The result can be used by the controller to adjust output commands being sent from the controller to each motor. In this example, the traction control system utilizes proportional control to adjust the wheel speeds.

In another exemplary embodiment, a different algorithm 400 can be used to improve traction control. In this embodiment, a ground speed estimate or measurement is determined and then compared to estimates of each wheel speed. This algorithm 400 is similar to the previously-described algorithm 300 except that the performance of each step is in a reverse order. In step 402, for example, the vehicle ground speed estimate is determined. This reference ground speed is determined in step 316 above and compared to the computed vehicle centerline speeds, but in algorithm 400, this reference speed is determined at the beginning. The reference ground speed is an estimate of what speed the wheels should be rotating. This can be achieved in several ways. For example, the speed of each wheel can be measured and then averaged and the average wheel speed used as the reference speed. This can be advantageous if the vehicle is moving along a straight path and each wheel is rotating at approximately the same speed. Alternatively, the controller can select one of the measured wheel speeds. For instance, the controller can select the highest or lowest measured wheel speed. This can be advantageous if the vehicle is moving through a turn and the inner wheels are moving slower than the outer wheels.

The reference ground speed can be determined in other ways. For instance, radar technology can be used for measuring the vehicle speed. In addition, a global positioning sensor (GPS) can also be used for measuring the speed. Some articulating vehicles can include both powered wheels and unpowered wheels. An unpowered wheel moves at about the same speed as the vehicle and a speed sensor (e.g., encoder or resolver) can be used to measure its speed. Alternatively, the vehicle 200 in FIG. 2 can include an accelerometer 238 (e.g., part of the user control sensor) which measures vehicle acceleration. The vehicle controller 226 can receive the vehicle acceleration measurement from the accelerometer 238 and compute a reference ground speed via a known integration method. Each of these techniques does not consider articulation or the articulating angle velocity, and thus are only used for establishing a reference speed.

In step 404, the steering angle ratio is determined in the same manner as it is calculated in step 312 above. The steering angle ratio can be used in step 406 to calculate an expected static ground speed at each wheel. This calculation can be made by dividing the vehicle ground speed by the articulation or steering angle ratio.

In step 408, a steering velocity offset can be computed in the same manner as it is calculated in step 308 above. The steering velocity offset calculation can be used in step 410 to obtain an expected ground speed at each wheel. To do so, the steering velocity offset calculation from step 410 is subtracted from the static ground speeds determined in step 406.

In step 412, the wheel radius can be determined for each wheel in a manner similar to that of step 304 above. The wheel radius determination can be used in step 414 to calculate a reference wheel speed for each wheel. The determination made in step 414 is similar to that of step 306. In the case of a vehicle having four wheels, the result of step 414 is four different reference wheel speeds. In step 416, the expected speed of each wheel can be determined. The expected wheel speed is calculated by dividing the instantaneous ground speed from step 414 by the wheel radius determined in step 412. Also in step 416, the speed of each wheel can be measured. The measurement, for example, can be based on the output of each motor driving a corresponding wheel.

In step 418, the measured wheel speeds can be compared to each expected wheel speed determined in step 416. To improve traction control, the measured speed and expected speed for each wheel are ideally approximately the same. In other words, the difference between the measured speed and expected speed is desirably about zero. In the event the difference is not approximately zero, the controller can send commands to the individual motors to adjust the speed of each wheel to drive the difference between speeds towards zero. As a result, by comparing the adjusted wheel speed to the expected wheel speed, or reference speed, the algorithm 400 can separate the effects of ground speed, articulation angle, articulation angle velocity, and slip. In addition, the traction control system can minimize slip without disregarding the kinematics of the vehicle.

An additional advantage to the embodiments described above is the ability to estimate vehicle speed (e.g., vehicle ground speed or reference ground speed). For instance, each wheel speed is being measured and the corresponding measurements are sent to the controller. In the event there are four wheels, the controller receives four different wheel speeds. If the vehicle is traveling in a straight line, the four speeds will be substantially the same. If the vehicle is turning, however, the wheels on the inside of the turn will be moving at a slower speed than the wheels on the outside.

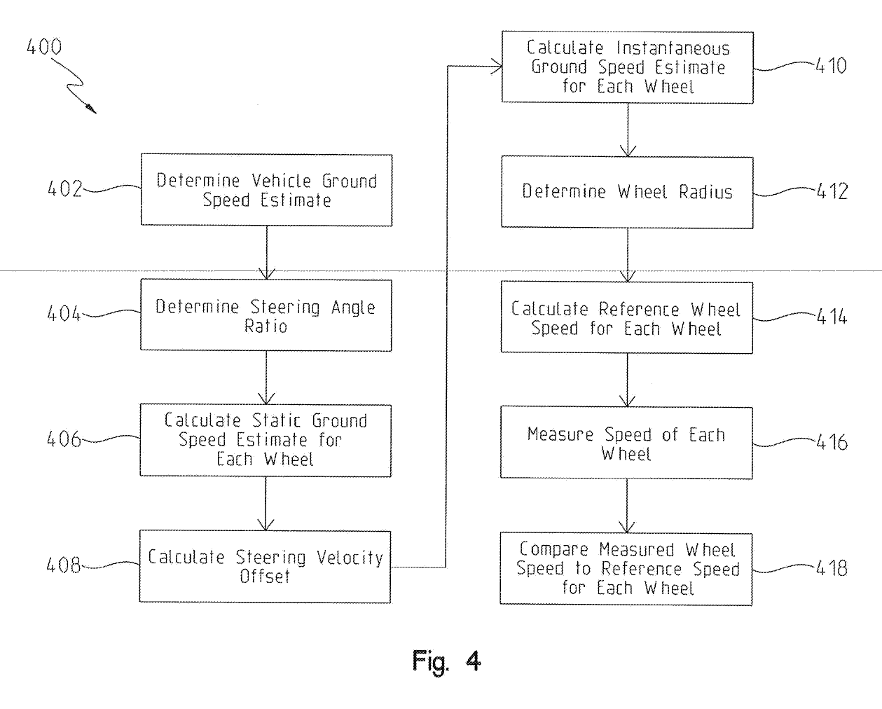

In the event a vehicle is accelerating, i.e., when torque at each wheel tends to accelerate the wheel, the wheel that performs under the best tractive conditions is likely the one resulting in the slowest vehicle speed estimate. This wheel is most likely operating at the kinematically expected speed, whereas the other wheels (which may actually be rotating faster) are likely slipping and therefore would not be optimally selected as the estimated vehicle speed. Alternatively, if a vehicle is braking, the torque at each wheel tends to decelerate the wheel. In this case, the wheel performing under the best tractive conditions is likely the one resulting in the fastest vehicle speed estimate. As a result, this wheel is most likely operating at the kinematically expected speed, whereas the other wheels are likely skidding and therefore would not be optimally selected as the estimated vehicle speed. Both of these two examples can be used for determining the reference ground speed in step 402 of FIG. 4.

In the above described embodiments, the ability to determine a “vehicle ground speed estimate” is not a requirement of using the kinematically corrected wheel speed measurements for traction control. Instead, the different speeds can simply be compared to one another to improve the traction of a vehicle (e.g., in step 316 of the algorithm). For example, the left rear and right rear vehicle speed estimates can be controlled the same. In addition, the left front and right front vehicle speeds can be controlled the same, while the average front axle vehicle speed and the average rear axle vehicle speed estimates can be controlled the same. As a result, the kinematics of turning a vehicle are considered and compensated for in these different comparisons. Thus, a determination is made for the correct reference speed for each wheel.

The individual vehicle speed estimates and comparison results for determining a representative vehicle ground speed can be displayed to a vehicle operator. These results can further be done independently of their use for traction control.

The traction control process described above can be utilized for any articulation vehicle having independently powered wheels. For instance, the process can be used for operating a front loader, a dump truck, a motor grader, a skidder, etc.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

1. A method of compensating for vehicle kinematics in a traction control system of an articulated vehicle, the vehicle having an independently-powered wheel, the method comprising:
measuring a speed of the wheel;
calculating an instantaneous ground speed of the wheel;
calculating a static ground speed of the wheel;
calculating a centerline ground speed of the wheel; and
comparing the centerline ground speed of the wheels to a reference speed.

2. The method of claim 1, further comprising:
determining a radius of the wheel;
calculating an angular velocity of the wheel from the measured speed; and
calculating the instantaneous ground speed of the wheel based on the radius and angular velocity of the wheel.

3. The method of claim 1, further comprising calculating an articulation velocity offset of the wheel.

4. The method of claim 3, further comprising:
measuring an articulation angle of the vehicle;
determining an articulation angle velocity based on the measured articulation angle;
determining a treadwidth value; and
calculating a vehicle geometry function of the vehicle;
wherein, the articulation velocity offset is a function of the articulation angle velocity, the treadwidth value, and the vehicle geometry function.

5. The method of claim 4, further comprising calculating the static ground speed based on the articulation velocity offset and calculated instantaneous ground speed of the wheel.

6. The method of claim 1, further comprising:
determining a treadwidth value and wheel base value;
determining a turning radius of the vehicle; and
calculating an articulation angle ratio based on the treadwidth value, wheel base value, and turning radius.

7. The method of claim 6, further comprising calculating the centerline ground speed based on the articulation angle ratio and calculated static ground speeds of the wheel.

8. The method of claim 1, further comprising:
measuring a speed of a second independently powered wheel;
calculating a centerline ground speed of the second independently powered wheel;
determining the reference speed based on the calculated centerline ground speed of each wheel or an estimate of vehicle ground speed;
calculating the difference between the centerline ground speeds of the wheels and the reference speed; and
controlling the measured speeds of the independently powered wheels until the calculated difference is approximately zero.

9. The method of claim 8, further comprising:
measuring a speed of a third independently powered wheel;
calculating a centerline ground speed of the third independently powered wheel;
determining the reference speed based on the calculated centerline ground speed of each wheel or an estimate of vehicle ground speed;
calculating the difference between the centerline ground speeds of the wheels and the reference speed; and
controlling the measured speeds of the independently powered wheels until the calculated difference is approximately zero.

10. A method of reducing slip in an articulating vehicle, the vehicle having one or more independently-powered wheels, comprising:
determining a reference vehicle speed;
calculating a static ground speed of the one or more wheels based on the reference vehicle speed;
calculating an instantaneous ground speed of the one or more wheels based on the calculated static ground speeds;
calculating expected speeds of the one or more wheels based on the calculated instantaneous ground speeds;
measuring a speed of the one or more wheels; and
comparing the measured speed of the one or more wheels to the calculated expected speed of the one or more wheels.

11. The method of claim 10, wherein the determining the reference vehicle speed comprises averaging the measured speeds of the one or more wheels.

12. The method of claim 10, wherein the determining the reference vehicle speed comprises selecting the slowest measured speed or the fastest measured speed of the one or more wheels.

13. The method of claim 10, wherein the determining the reference ground speed comprises measuring vehicle speed with an accelerometer, a radar detector, a global positioning sensor, or an unpowered wheel coupled to the vehicle.

14. The method of claim 10, further comprising:
determining a treadwidth value and a wheel base value;
determining a turning radius of the vehicle; and
calculating an articulation angle ratio based on the treadwidth value, wheel base value, and turning radius.

15. The method of claim 14, further comprising calculating the static ground speed based on the articulation angle ratio and reference ground speed.

16. The method of claim 10, further comprising calculating an articulation velocity offset of the one or more wheels.

17. The method of claim 16, further comprising:
measuring an articulation angle of the vehicle;
determining an articulation angle velocity based on the measured articulation angle;
determining a treadwidth value for the one or more wheels; and
calculating a vehicle geometry function;
wherein, the articulation velocity offset is a function of the articulation angle velocity, the treadwidth value, and the vehicle geometry function.

18. The method of claim 17, further comprising calculating the instantaneous ground speed based on the articulation velocity offset and calculated static ground speed of the one or more wheels.

19. The method of claim 10, further comprising:
determining a radius of each of the one or more wheels; and
calculating the expected speeds of the one or more wheels based on the radius and calculated instantaneous ground speeds of each wheel.

20. The method of claim 10, further comprising:
calculating the difference between the expected speed and measured speed of the one or more wheels; and
controlling the speed of each wheel until the difference in the expected speed and measured speed of each wheel is approximately zero.
